(19) United States
(12) Patent Application Publication
(10) Pub. No.: US 2008/0105815 A1
(43) Pub. Date: May 8, 2008

(54) Connecting assembly

(75) Inventor: Cheng-Hung Chiu, Taichung (TW)

Correspondence Address: BACON & THOMAS, PLLC, 625 SLATERS LANE, FOURTH FLOOR, ALEXANDRIA, VA, 22314, US

(73) Assignee: Rexon Industrial Corp., Ltd., Taichung (TW)

(21) Appl. No.: 11/979,666

(22) Filed: Nov. 7, 2007

(30) Foreign Application Priority Data
Nov. 8, 2006 (TW) 095141429

(51) Int. Cl. F16M 13/00

(52) U.S. Cl. 248/674

(57) ABSTRACT

A connecting assembly is adapted to connect a power tool and a stand. The stand is configured to support the power tool at a predetermined height above the ground. The stand forms at least one hole on its top. The connecting assembly includes a plug having a head and a lock section, a base fixed on the stand and correspondingly located underneath the hole, and a lock assembly. The head is larger than the hole. When the plug is inserted into the bottom of the power tool, through the hole and into the base, the lock assembly is movable relative to the base to selectively lock or unlock the lock section. Thus, the power tool and the stand can be easily and quickly connected or seperarated without the use of any tools.

### BACKGROUND

1. Field of the Invention

The present invention relates to a connecting assembly and more particularly, to a connecting assembly for connecting a power tool and a stand.

2. Description of the Related Art

A power tool such as a table saw is conventionally mounted on a stand for having a predetermined height above the ground, such that the table saw can be operated more conveniently. A plurality of holes is bored through the bottom of the table saw, and a plurality of openings respectively corresponding to the holes is bored through the top of the stand. After disposing the table saw upon the stand, a user can insert a bolt into each corresponding set of the hole and the opening and screw a nut onto the bolt, thus the table saw and the stand are connected together securely.

However, tools are required in order to screw the nut onto the bolt. Additionally, the user has to bend down or squat down and use one hand to steady the bolt and reach the other hand under the bottom of the stand, so that the user can screw the nut onto the bolt successfully. Additionally, when separating the table saw and the stand, the user should loosen the bolts and nuts one by one. The aforementioned configuration is inconvenient and inefficient.

### SUMMARY

In view of the foregoing, an embodiment of the present disclosure aims to provide a connecting assembly to connect a power tool and a stand easily and quickly.

Accordingly, a connecting assembly includes a plug having a head and a lock section, and a base fixed upon the stand and located correspondingly to and underneath a hole bored through the top of the stand, and a lock assembly. The head of the plug is larger than the hole so that it does not pass through the hole. When the plug is inserted into the bottom of the power tool, through the hole and into the base, the lock assembly can be moved relative to the base to selectively engage the lock section in order to lock or unlock the lock section. In such a way, the power tool and the stand are connected together or separated easily and quickly without using any tools.

### BRIEF DESCRIPTION OF THE DRAWINGS

FIG. 1 is a perspective view, showing the status of using a connecting assembly according to a first embodiment to connect a table saw and a stand.

FIG. 2 is an exploded perspective view of the connecting assembly according to the first embodiment

FIG. 3 is a perspective and sectional view, showing the unlocked status of the connecting assembly according to the first embodiment.

FIG. 4 is a perspective and sectional view, showing the locked status of the connecting assembly according to the first embodiment.

FIG. 5 is a sectional view, showing the locked status of a connecting assembly according to a second embodiment.

FIG. 6 is a sectional view, showing the unlocked status of the connecting assembly according to the second embodiment.

FIG. 7 is a sectional view, showing the locked status of a connecting assembly according to a third embodiment.

FIG. 8 is a sectional view, showing the unlocked status of the connecting assembly according to the third embodiment.

FIG. 9 is a sectional view, showing the locked status of a connecting assembly according to a fourth embodiment.

FIG. 10 is a sectional view, showing the unlocked status of the connecting assembly according to the fourth embodiment.

### DETAILED DESCRIPTION OF VARIOUS EMBODIMENTS

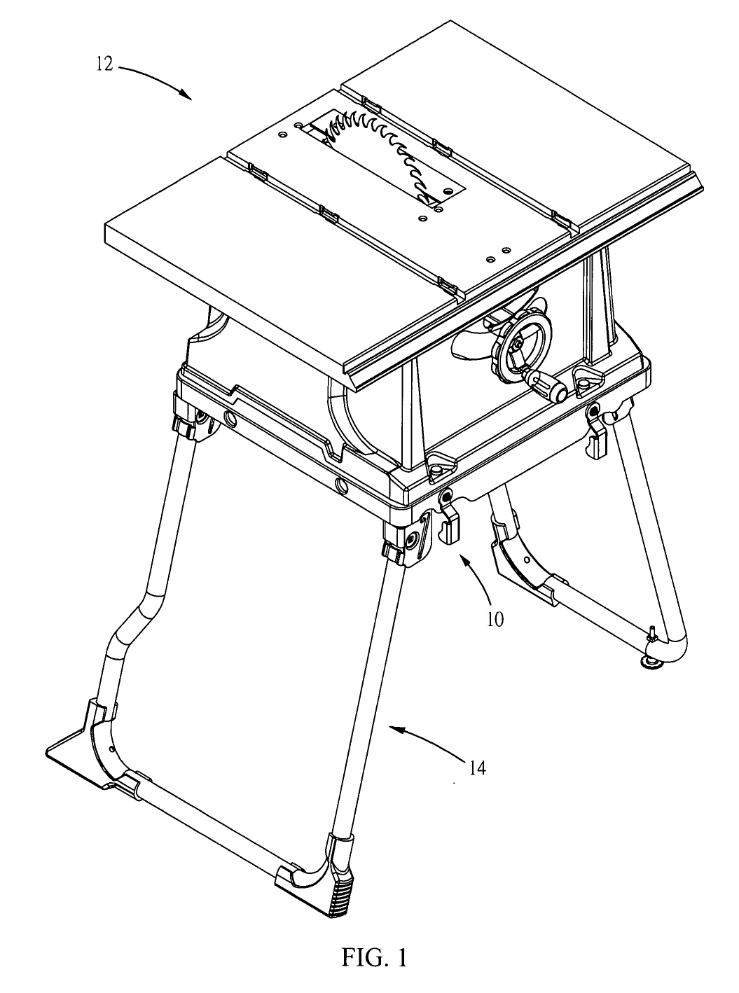

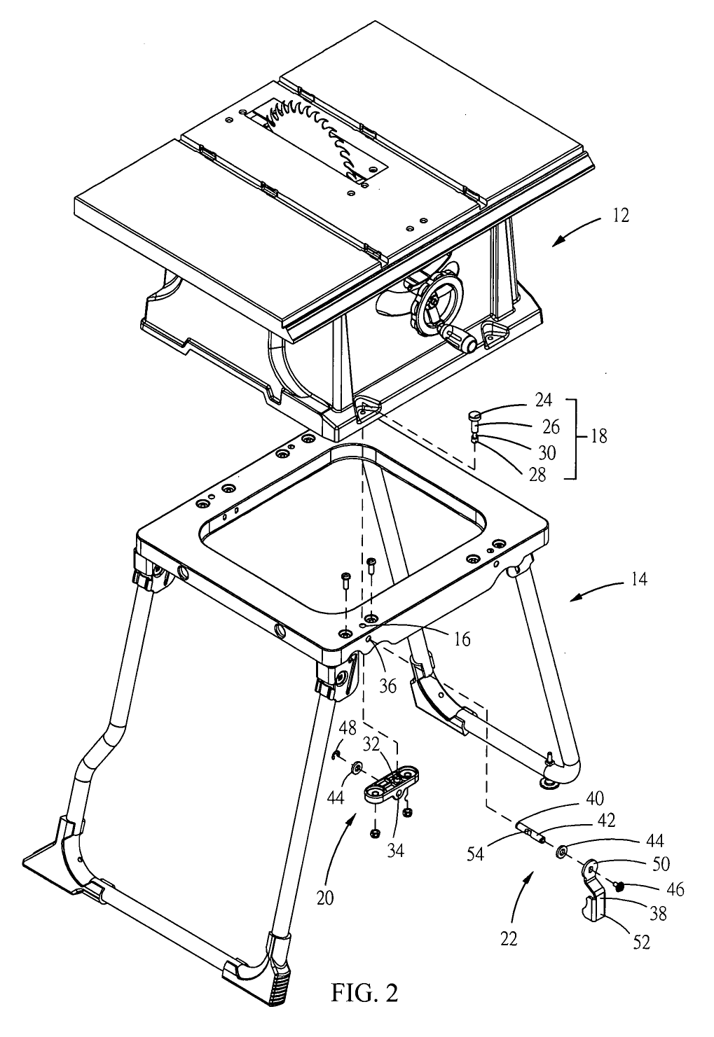

Referring to FIGS. 1 and 2, a connecting assembly 10 provided by a first embodiment is used to connect a power tool and a stand 14. The power tool is a commonly used woodworking machine, such as miter saw, table saw, scroll saw, band saw and sander, etc. A table saw 12 is taken as an example in the present embodiments. When performing a cutting operation, a user generally places the table saw 12 upon the stand 14 to have a predetermined height above the ground, such that the user can operate the table saw 12 conveniently. The top of the stand 14 is bored through with at least one hole 16. When a plug 18 is inserted into the bottom of the table saw 12, through the hole 16, and into a base 20 that is fixed on the stand 14 and is located underneath the hole 16 correspondingly, then the plug 18 can be locked by a lock assembly 22. Thus, the connecting assembly 10 is capable of mounting the table saw 12 securely onto the stand 14.

Referring to FIG. 2, the connecting assembly 10 of the first embodiment comprises a plug 18, a base 20 and a lock assembly 22.

The plug 18 is a cylindrical plug and includes a head 24, a body 26, a foot 28 and a lock section 30 that is defined sunken around the plug 18 between the body 26 and the foot 28. Wherein, the head 24 is larger than the hole 16, thus the head 24 cannot be passed through the hole 16.

A lead hole 32 and a through hole 34 are formed in the base 20. The lead hole 32 and the hole 16 are corresponding to each other. The through hole 34 and the lead hole 32 intercommunicate and are substantially perpendicular to each other. In the first embodiment, the sides of the stand 14 are also bored through with a round hole 36 respectively. The round hole 36 corresponds to the through hole 34.

The lock assembly 22 includes a rotatable part 38 and a round rod 42 having a circular groove 40 formed around its tail, two washers 44, a bolt 46 and a C-type retaining ring 48. There are many types of suitable rotatable parts 38, such as a spherical handle or a knob. In the first embodiment, the rotatable part 38 includes a front part 50 and a L-shaped handle 52. The front part 50 is joined together with the round rod 42 by utilizing the washers 44 and the bolt 46. When the L-shaped handle is rotated, the round rod 42 is revolved accordingly. When the round rod 42 joined with the rotatable part 38 is inserted into the round hole 36, and the through hole 34, the rotatable part 38 is located on the outside of the stand 14. Then the washer 44 firstly and the C-type retaining ring 48 secondly are connected with the circular groove 40, thus the round rod 42 cannot be removed from the through hole 34. When the L-shaped handle 52 is rotated, the round rod 42 is revolved in the through hole 34. A recess 54 with a curved surface is formed on the round rod 42. When the round rod 42 is inserted into the through hole 34, the recess 54 is located corresponding to a place where the lead hole 32 and the through hole 34 intercommunicate each other. The radius of the recess 54 is not smaller than the radius of lead hole 32.

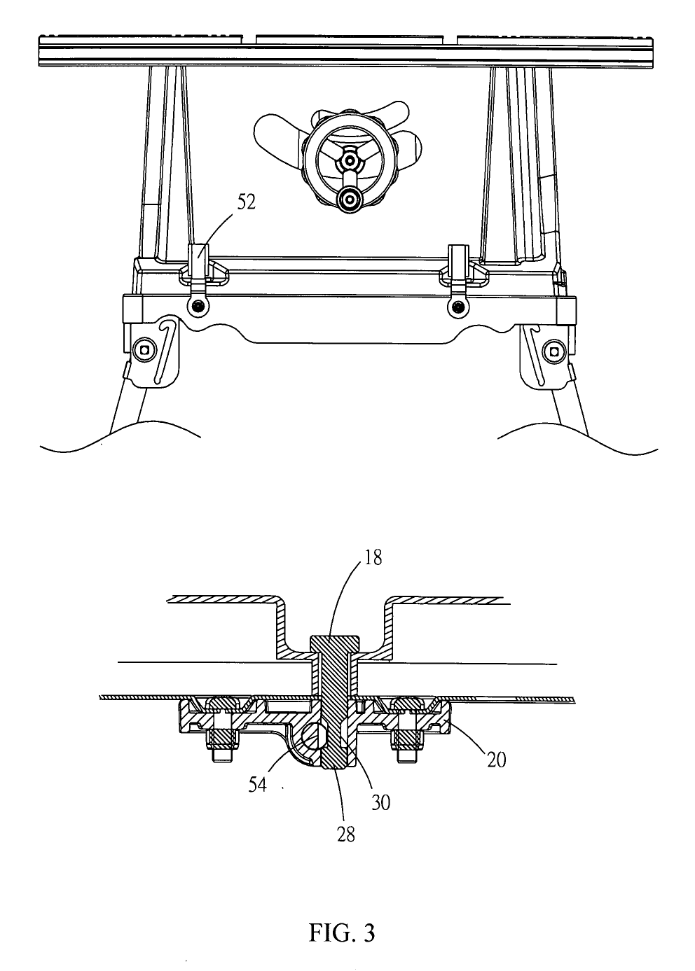

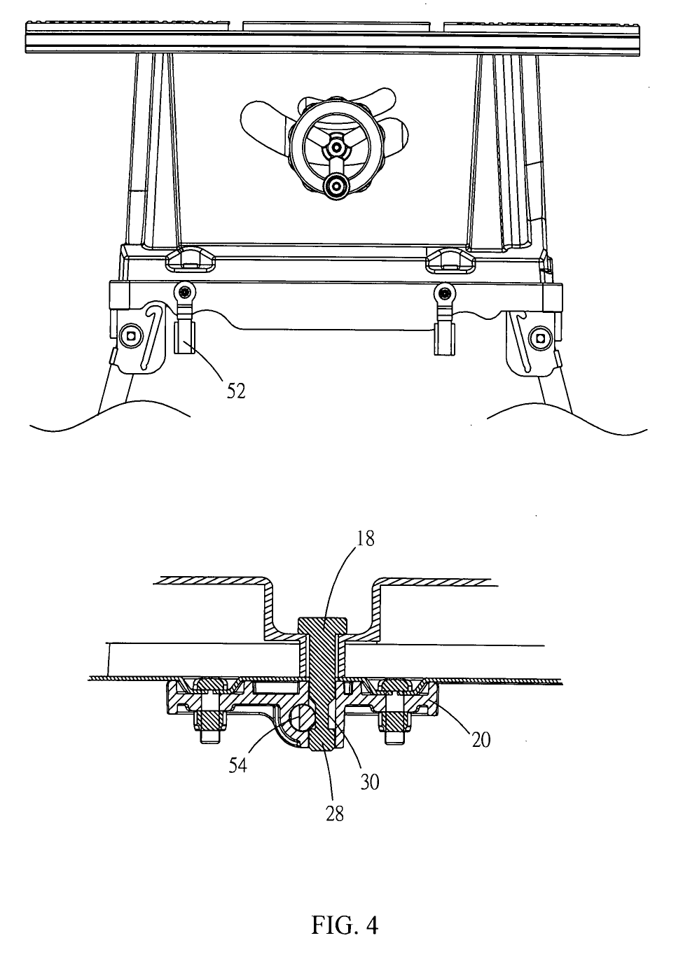

Referring to FIGS. 3 and 4, when the L-shaped handle 52 is rotated clockwise upward 180° from a position where the L-shaped handle 52 is naturally oriented downward, the recess 54 is located in a right opposite position to the lead hole 32. Then, the plug 18 is inserted into the bottom of the table saw 12, through the hole 16, and into the lead hole 32, thus the foot 28 of the plug 18 is passed through the recess 54, and the lock section 30 of the plug 18 is located in the place where the lead hole 32 and the through hole 34 intercommunicate each other. When the L-shaped handle 52 is rotated clockwise downward 180° to the position that the L-shaped handle 52 is naturally oriented downward, the recess 54 is rotated away from the lead hole 32, thus the plug 18 is locked by the round rod 42 at the lock section 30, such that the plug 18 cannot be pulled out and then the table saw 12 and the stand 14 are connected together. Furthermore, when the user rotates the L-shaped handle 52 clockwise upward 180° to position the recess 54 opposite to the lead hole 32, then the plug 18 can be pulled out, thus the table saw 12 and the stand 14 can be separated. In other words, the connecting assembly 10 provided by the first embodiment can be used to either connect or separate the table saw 12 and the stand 14 quickly without the use of any tools.

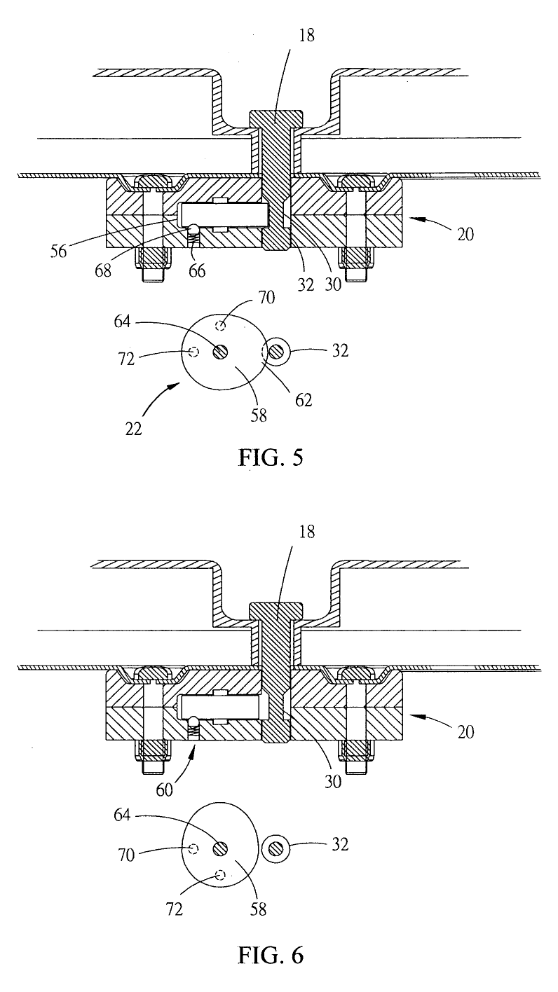

FIGS. 5 and 6 illustrate the locked and unlocked status of a connecting assembly of a second embodiment in accordance with the present disclosure. Referring to FIGS. 5 and 6, the connecting assembly comprises a plug 18, a base 20 and a lock assembly 22.

The plug 18 is the same as the described in the first embodiment.

The base 20 is fixed on the stand 14, and is correspondingly located underneath the hole 16 and includes a lead hole 32 and a cavity 56. The lead hole 32 corresponds to the hole 16. The cavity 56 and the lead hole 32 intercommunicate and are substantially perpendicular to each other.

The lock assembly 22 includes a rotatable cam 58, and a stop device 60 disposed between the cam 58 and the base 20. The cam 58 has a protruding portion 62. The distance from the protruding portion 62 to an axis 64 of the cam 58 is larger than the nearest distance from the periphery of the lead hole 32 to the axis of the cam 58. The stop device 60 includes a spring 66 and a steel ball 68 both disposed in the lower interior wall of the cavity 56, and a first set hole 70 and a second set hole 72 both formed in the bottom of the cam 58. The stop device 60 may be disposed reversely, for example the spring 66 and the steel ball 68 may be disposed in the bottom of the cam 58 and the first set hole 70 and the second set hole 72 may be formed in the lower interior wall of the cavity 56.

Referring to FIGS. 5 and 6, when the cam 58 is rotated such that the steel ball 68 is maintained in the first set hole 70, the protruding portion 62 of the cam 58 is maintained away from the place where the lead hole 32 and the cavity 56 intercommunicate. Then the plug 18 is inserted into the bottom of the table saw 12, through the hole 16, and into the lead hole 32, and the lock section 30 of the plug 18 is located in the place where the lead hole 32 intercommunicates with the cavity 56. Then when the cam 58 is rotated again such that the steel ball 68 is maintained in the second set hole 72, the protruding portion 62 of the cam 58 extends into the place where the lead hole 32 and the cavity 56 intercommunicate, thus the plug 18 is locked by the protruding portion 62 of the cam 58 at the lock section 30, such that the plug 18 cannot be removed. Thus, the table saw 12 and the stand 14 are connected together. Conversely, when the cam 58 is rotated again such that the steel ball 68 is maintained in the first set hole 70, the protruding portion 62 of the cam 58 is maintained away from the place where the lead hole 32 and the cavity 56 intercommunicate, thus the plug 18 can be pulled out, such that the table saw 12 and the stand 14 can be separated. In other words, the table saw 12 and the stand 14 can either be connected or separated quickly without the use of any tools by utilizing the connecting assembly 10 according to the second embodiment.

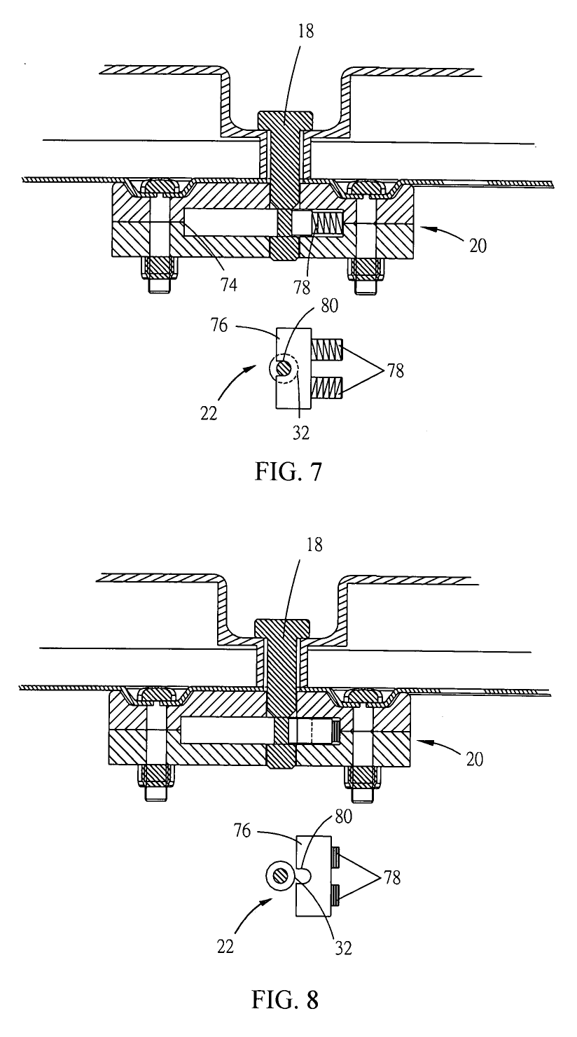

FIGS. 7 and 8 illustrate the locked and unlocked status of a connecting assembly of a third embodiment in accordance with the present disclosure. Referring to FIGS. 7 and 8, the connecting assembly comprises a plug 18, a base 20 and a lock assembly 22.

The plug 18 is the same as the described in the first embodiment.

The base 20 is fixed on the stand 14, and is correspondingly located underneath the hole 16 and includes a lead hole 32 and a cavity 74. The lead hole 32 corresponds to the hole 16. The cavity 74 and the lead hole 32 intercommunicate and are substantially perpendicular to each other.

The lock assembly 22 includes a sliding plate 76 that is slidable leftward and rightward in the cavity 74, and a spring 78 installed in the cavity 74. One end of the spring 78 contacts one end of the sliding plate 76 and the other end contacts one end of the cavity 74. A notch 80 is formed in the other end of the sliding plate 76 that is opposite to the end contacting the spring. The notch 80 is located in a place corresponding to the lead hole 32 and is able to lock the lock section 30.

Referring to FIGS. 7 and 8, when the spring 78 is compressed to move the sliding plate 76 rightward, the notch 80 is maintained away from the place corresponding to the lead hole 32. Then the plug 18 is inserted into the bottom of the table saw 12, through the hole 16, and into the lead hole 32, and the lock section 30 is located in a place where the lead hole 32 and the cavity 74 intercommunicate. When the spring 78 is released to make the sliding plate 76 move back to the original position, the plug 18 is locked by the notch 80 at the lock section 30, thus the plug 18 cannot be removed, such that the table saw 12 and the stand 14 are connected together. Moreover, when the spring 78 is compressed to move the sliding plate 76 rightward again, the notch 80 is moved away from the place corresponding to the lead hole 32, thus the plug 18 can be pulled out, such that the table saw 12 and the stand 14 can be separated. In other words, the table saw 12 and the stand 14 can either be connected or separated quickly without the use of any tools by utilizing the connecting assembly 10 according to the third embodiment.

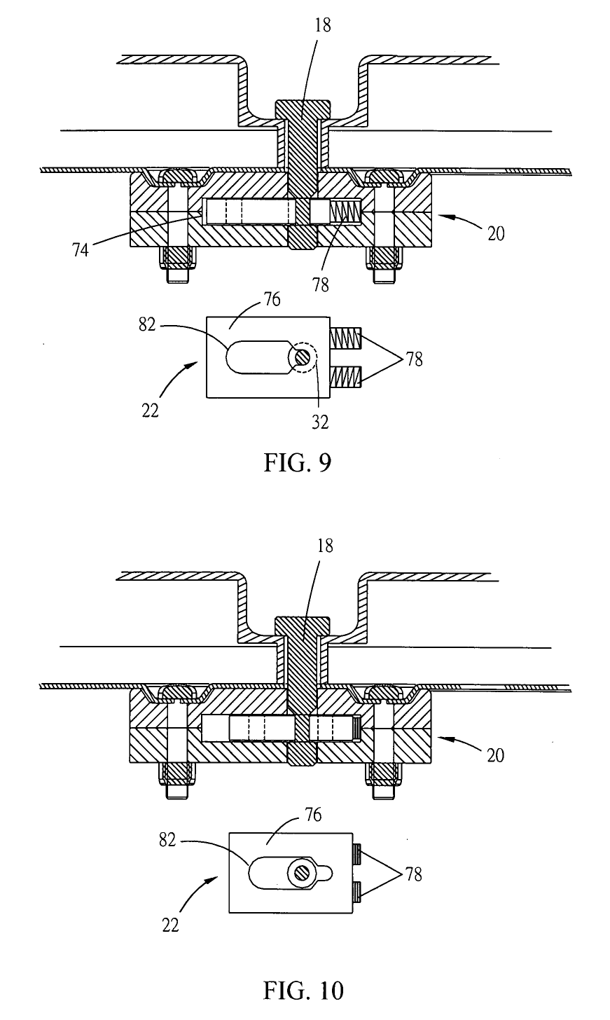

FIGS. 9 and 10 illustrate the locked and unlocked status of a connecting assembly of a fourth embodiment in accordance with the present disclosure. Referring to FIGS. 9 and 10, the connecting assembly comprises a plug 18, a base 20 and a lock assembly 22.

The plug 18 and the base 20 are the same as the described in the third embodiment.

The lock assembly 22 includes a sliding plate 76 that slidable leftward and rightward in the cavity 74, and a spring 78 installed in the cavity 74. One end of the spring 78 contacts one end of the sliding plate 76 and the other end contacts one end of the cavity 74. A long slot 82 is formed in the sliding plate 76 and includes a wider end and a narrower end. The long slot 82 corresponds to the lead hole 32. The plug 18 can be passed through the wider end of the long slot 82, but cannot be passed through the narrower end of the long slot 82. Thus, the lock section 30 can be locked by the narrower end of the long slot 82.

Referring to FIGS. 9 and 10, when the spring 78 is compressed to move the sliding plate 76 rightward, the wider end of the long slot 82 is correspondingly located with respect to the lead hole 32. Then the plug 18 is inserted into the bottom of the table saw 12, through the hole 16, and into the lead hole 32, thus the foot 28 is passed through the wider end of the long slot 82, and the lock section 30 is located in a place where the lead hole 32 and the cavity 74 intercommunicate. When the spring 78 is released to make the sliding plate move back to the original position, the plug 18 is locked by the narrower end of the long slot 82 at the lock section 30, thus the plug 18 cannot be removed, such that the table saw 12 and the stand 14 are connected together. Moreover, when the spring 78 is compressed to move the sliding plate 76 rightward again, the wider end of the long slot 82 is moved back to the place corresponding to the lead hole 32, thus the plug 18 can be pulled out, such that the table saw 12 and the stand 14 can be separated. In other words, the table saw 12 and the stand 14 can either be connected or separated quickly without the use of any tools by utilizing the connecting assembly 10 according to the fourth embodiment.

The foregoing discussion discloses and describes merely exemplary embodiments of the present invention for purposes of illustration only. One skilled in the art will readily recognize from such discussion, and from the accompanying drawings and claims, that various changes, modifications, and variations may be made therein without departing from the spirit and scope of the invention as defined in the following claims.

1. A connecting assembly configured to selectively connect a power tool and a stand configured to support said power tool defining at least one stand hole therethrough, said connecting assembly comprising:
a plug having a head and a lock section, the lock section configured to be inserted into a bottom of a power tool and through said at least one stand hole, the head being sized larger than said at least one stand hole;
a base mounted to said stand and correspondingly located underneath said at least one stand hole; and
a lock assembly configured to be movable relative to said base to selectively engage said lock section.

2. The connecting assembly according to claim 1, wherein said lock section is a groove.

3. The connecting assembly according to claim 1, wherein said lock assembly includes a rod member being revolvable between a lock position and a unlock position.

4. The connecting assembly according to claim 3, wherein said base forms a lead hole corresponding to said at least one stand hole and a through hole intercommunicating and substantially perpendicular to said lead hole; said rod member is inserted into said through hole; wherein said plug is inserted into said lead hole to position said lock section at a place where said lead hole and said through hole intercommunicate.

5. The connecting assembly according to claim 4, wherein said rod member includes a recess portion defined thereupon, wherein when said rod member is rotated in said through hole, and the recess is selectively positioned opposed to and adjacent to the place where said lead hole and said through hole intercommunicate so as to respectively lock and unlock said lock section.

6. The connecting assembly according to claim 5, wherein said rod member includes a handle and a round rod joined with said handle.

7. The connecting assembly according to claim 1, wherein said base forms a lead hole corresponding to said at least one stand hole and a cavity intercommunicating and substantially perpendicular to said lead hole, and wherein said plug is inserted into said lead hole.

8. The connecting assembly according to claim 7, wherein said lock assembly includes a sliding plate slidable in said cavity.

9. The connecting assembly according to claim 8, wherein said sliding plate forms a notch corresponding to said lead hole and is slidable relative to said cavity to selectively engage said lock section.

10. The connecting assembly according to claim 8, wherein said lock assembly further includes a spring having first and second ends, the first end of said spring contacts one side of said cavity, and the second end contacts one side of said sliding plate.

11. A power tool comprising:
a machine configured to run said power tool having at least one opening defined in a bottom thereof;
a stand including a plurality of legs to support said machine, and at least one stand hole defined in a top thereof respectively corresponding to said at least one opening;
at least one plug having a head and a lock section the lock section configured to be inserted into said at least one opening and said at least one stand hole respectively, wherein said head is sized larger than said at least one stand hole;
at least one base mounted to said stand and correspondingly located underneath said at least one stand hole; and
at least one lock assembly configured to be moveable relative to said at least one base to selectively engage said lock section for connecting said power tool and said stand.

12. The power tool according to claim 11, wherein said lock section is a groove.

13. The power tool according to claim 11, wherein said at least one lock assembly includes a rotatable cam.

14. The power tool according to claim 13, wherein said at lease one base includes a lead hole corresponding to said at least one stand hole and a cavity intercommunicating and substantially perpendicular to said lead hole, said rotatable cam disposed in said cavity and rotatable to selectively protrude into a place where said lead hole and said cavity intercommunicate to lock said lock section.

15. The power tool according to claim 14, wherein said at least one lock assembly further includes a stop device having a spring and a ball both installed in the upper interior wall or the lower interior wall of said cavity, and said rotatable cam forms a first set hole and a second set hole positioned opposite to said ball.

16. The power tool according to claim 11, wherein said at least one base includes a lead hole corresponding to said at least one stand hole and a cavity intercommunicating and substantially perpendicular to said lead hole, and said plug is inserted into said lead hole.

17. The power tool according to claim 16, wherein said at least one lock assembly includes a sliding plate slidable in said cavity.

18. The power tool according to claim 17, wherein said sliding plate forms a notch corresponding to said lead hole and is slidable relative to said cavity to selectively engage said lock section.

19. The power tool according to claim 11, wherein said power tool is a table saw.
